(19) United States
(12) Patent Application Publication
(10) Pub. No.: US 2024/0357341 A1
(43) Pub. Date: Oct. 24, 2024

(54) ELECTRONIC DEVICE AND METHOD OF WIRELESS COMMUNICATION

(71) Applicant: MEDIATEK INC., Hsin-Chu (TW)

(72) Inventors: Kun-Lin WU, Hsinchu (TW); Wei-Yu CHEN, Hsinchu (TW)

(21) Appl. No.: 18/603,398

(22) Filed: Mar. 13, 2024

Related U.S. Application Data
(60) Provisional application No. 63/497,242, filed on Apr. 20, 2023.

(51) Int. Cl. H04W 8/20; H04W 8/22; H04W 72/0446; H04W 72/0453

(52) U.S. Cl. CPC H04W 8/20; H04W 8/22; H04W 72/0446; H04W 72/0453

(57) ABSTRACT

An electronic device is provided. The electronic device includes a first subscriber identity module (SIM), a second SIM, and a processor. The processor is configured to merge a first signal from the first SIM and a second signal from the second SIM and transmit the first signal and the second signal through a radio frequency front end (RFFE) transmission path concurrently, in response to a determination that the first signal and the second signal are intra-band signals and the first SIM and the second SIM share one RFFE transmission path.

### CROSS REFERENCE TO RELATED APPLICATIONS

This application claims priority to U.S. Provisional Application Ser. No. 63/497,242, filed on Apr. 20, 2023, the entirety of which is incorporated by reference herein.

### BACKGROUND OF THE INVENTION

### Field of the Invention

The present invention relates to wireless communication, and, in particular, to a wireless communication method that supports dual SIM dual active (DSDA) with one transmission path.

### Description of the Related Art

Many modern electronic devices (such as cell phones) are equipped with two subscriber identity module (SIM) cards. Dual SIM dual active (DSDA) and dual-receive DSDA (DR-DSDA) are two technologies allow two SIMs to operate simultaneously. In other words, two SIMs can be active at the same time.

DSDA supports concurrent uplink communication. To implement concurrent uplink communication, DSDA requires two independent radio frequency front-end (RFFE) transmission paths. On the other hand, DR-DSDA only supports concurrent downlink communication for two SIMs. Thus, DR-DSDA only requires a shared RFFE transmission path.

Although DSDA provides superior performance over DR-DSDA, DSDA has a more stringent hardware requirement. When there's only one RFFE transmission path, it is only possible to perform DR-DSDA. Thus, a mechanism that supports DSDA with one RFFE transmission path is needed.

### BRIEF SUMMARY OF THE INVENTION

An embodiment of the present invention provides an electronic device. The electronic device comprises a first subscriber identity module (SIM), a second SIM, and a processor. The processor is configured to merge a first signal from the first SIM and a second signal from the second SIM and transmit the first signal and the second signal through a radio frequency front end (RFFE) transmission path concurrently, in response to a determination that the first signal and the second signal are intra-band signals and the first SIM and the second SIM share one RFFE transmission path.

An embodiment of the present invention also provides a method of wireless communication. The method comprises determining, via a processor, whether a first signal from a first SIM and a second signal from a second SIM are intra-band signals. The method also comprises determining, via the processor, whether the first SIM and the second SIM share one RFFE transmission path. The method also comprises merging, via the processor, the first signal and the second signal and transmit the first signal and the second signal through a RFFE transmission path concurrently, in response to a determination that the first signal and the second signal are intra-band signals and the first SIM and the second SIM share one RFFE transmission path.

### BRIEF DESCRIPTION OF THE DRAWINGS

The present invention can be more fully understood by reading the subsequent detailed description and examples with references made to the accompanying drawings, wherein:

FIG. 1 is a schematic diagram of a communication system in accordance to embodiments of the present disclosure;

FIG. 2 is a flow diagram of a method in accordance to the embodiments of the present disclosure; and

FIG. 3 is a flow diagram of a method in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

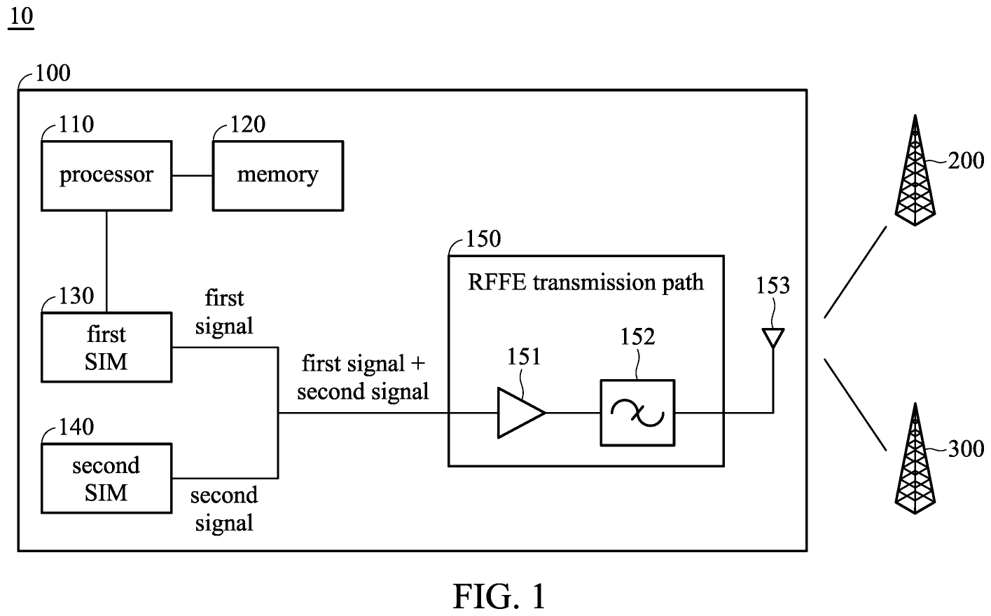

Refer to FIG. 1, FIG. 1 is a schematic diagram of a communication system 10 in accordance to embodiments of the present disclosure. The communication system 10 comprises an electronic device 100, a first base station 200, and a second base station 300. In some embodiments, the first base station 200 and the second base station 300 may in the different networks or cells. In some embodiments, the first base station 200 and the second base station 300 may be access points, access terminals, evolved Node-Bs (eNBs), or gNodeBs (gNB).

The electronic device 100 comprises a processor 110, a memory 120, first subscriber identity module (SIM) 130, SIM 140, and radio frequency front end (RFFE) transmission path 150. The electronic device 100 may also comprise component that isn't shown in FIG. 1. For example, the electronic device 100 may also comprise user interface device, display, inner power supply, and/or at least one RFFE reception path. In some embodiments, the first SIM 130 and the second SIM 140 may share one RFFE reception path. In other embodiments, the electronic device 100 may comprise two independent RFFE reception paths, and the first SIM 130 and the second SIM 140 respectively connects to one RFFE reception path. The electronic device 100 may perform various functions to implement processes and methods described herein, such as methods for supporting DSDA with one transmission path in accordance to embodiments of the present disclosure. The electronic device 100 may be a part of a user equipment (UE) or implemented in a user equipment. For example, the electronic device 100 may be a mobile apparatus, a user equipment, or a mobile terminal. In some embodiments, electronic device 100 is implemented in a smartphone, a smartwatch, a tablet computer, or a notebook computer. The electronic device 100 may be implemented in the form of one or more integrated-circuit (IC) chips.

The processor 110 controls operations of the electronic device 100. The processor 110 provides the required process ability to perform operating systems, programs, software, modules, applications, and functions of the electronic device 100. In some embodiments, the processor 110 may be implemented in the form of hardware with electronic components including transistors, diodes, capacitors, resistors, or inductors. These components are configured to achieve specific purposes in accordance with the present disclosure. Thus, the processor 110 is a special-purpose machine specifically configured to perform specific tasks including method of the present disclosure. For example, the processor 110 may be a general-purpose micro-processor, a central processing unit, the combination of the general-purpose processor and special purpose processor, and/or related chip set.

The memory 120 stores data required by the processor 110. The memory 120 may include non-volatile memories, such as read only memory (ROM) and flash memory. The memory 120 may also include volatile memories, such as dynamic random access memory (DRAM) and static random access memory (SRAM). In some embodiments, the memory 120 stores programs, such as computer-readable instructions. The programs can be operated by the processor 110. When the programs are operated by the processor 110, the programs cause the processor 110 to implement methods according to the embodiments of the present disclosure.

The electronic device 100 is able to wirelessly communicate with the first base station 200 and the second base station 300 using the first SIM 130 and/or the second SIM 140. The first SIM 130 and the second SIM 140 may be active at the same time. In other words, the electronic device 100 may apply DSDA or DR-DSDA technology to communicate with the first base station 200 and the second base station 300. The electronic device 100 may also apply dual SIM dual standby (DSDS) technology to communicate with the first base station 200 and the second base station 300.

DSDA supports concurrent uplink communication and concurrent downlink communication for the first SIM 130 and the second SIM 140. To implement concurrent uplink communication, DSDA requires two independent radio frequency front end (RFFE) transmission paths, while DSDA requires two independent RFFE receive paths or a shared RFFE receive path. On the other hand, DR-DSDA only supports concurrent downlink communication for the first SIM 130 and the second SIM 140 and supports uplink communication through time-sharing. Thus, DR-DSDA only requires a shared RFFE transmission path. DR-DSDA also requires two independent RFFE receive path or a shared RFFE receive path. On the contrary, DSDS allows only one SIM to be active at one time. For example, when one SIM (the first SIM 130) is transmitting or receiving signal, another SIM (the second SIM 140) may not transmit or receive signal.

In some embodiments, one of the first SIM 130 and the second SIM 140 can transmit or receive signal while another one is transmitting or receiving signal. For example, the electronic device 100 may perform a first communication related to the first base station 200 using the first SIM 130. The electronic device 100 may also perform a second communication related to the second base station 300 using the second SIM 140. In some embodiments, the first communication and second communication may be different applications. For example, the first communication may be voice data transmission (such as a phone call), and the second communication may be network service (such as a connection to Internet).

In the embodiment shown in FIG. 1, the first SIM 130 and the second SIM 140 share one RFFE transmission path 150. The RFFE transmission path 150 comprises a power amplifier 151, a filter 152, and at least one antenna 153. The RFFE transmission path 150 is configured to transmit signals output from the first SIM 130 and the second SIM 140. In the embodiment shown in FIG. 1, the first SIM 130 outputs a first signal, and the second SIM 140 outputs a second signal. In some embodiments, the first signal is related to the first communication, and the second signal is related to the second communication. In some embodiments, the first signal and the second signal may be intra-band signals or inter-band signals. In some embodiments, the first signal and the second signal may have same or different frequencies, and/or be scheduled to be transmitted on same or different frequencies. When the processor 110 determines that the first signal and the second signal are intra-band signals, the processor 110 merges the first signal and the second signal and concurrently transmits the first signal and the second signal through the RFFE transmission path 150 to the first base station 200 and the second base station 300. In other words, the merged signal is transmitted to the first base station 200 and the second base station 300 through the RFFE transmission path 150. In this disclosure, the first signal and the second signal being intra-band signals may referred to that the first signal and the second signal have (or be scheduled on) the same frequency, the first signal and the second signal are transmitted on the same frequency resource, or the first signal and the second signal are in the same frequency band.

In some embodiments, the processor 110 overlaps (superposes) the first signal and the second signal in the time domain to generate the merged signal. In some embodiments, the processor 110 sums up the first signal and the second signal to generate the merged signal. In some embodiments, the first signal and the second signal are transmitted on the same carrier. Thus, the processor 110 overlaps (sums up) the first signal and the second signal in the time domain to generate the merged signal and transmits the merged signal on the predetermined carrier through the RFFE transmission path 150. By merging two signals and transmitting the merged signal through a RFFE transmission path, the embodiments of the present disclosure can implement DSDA with only one RFFE transmission path.

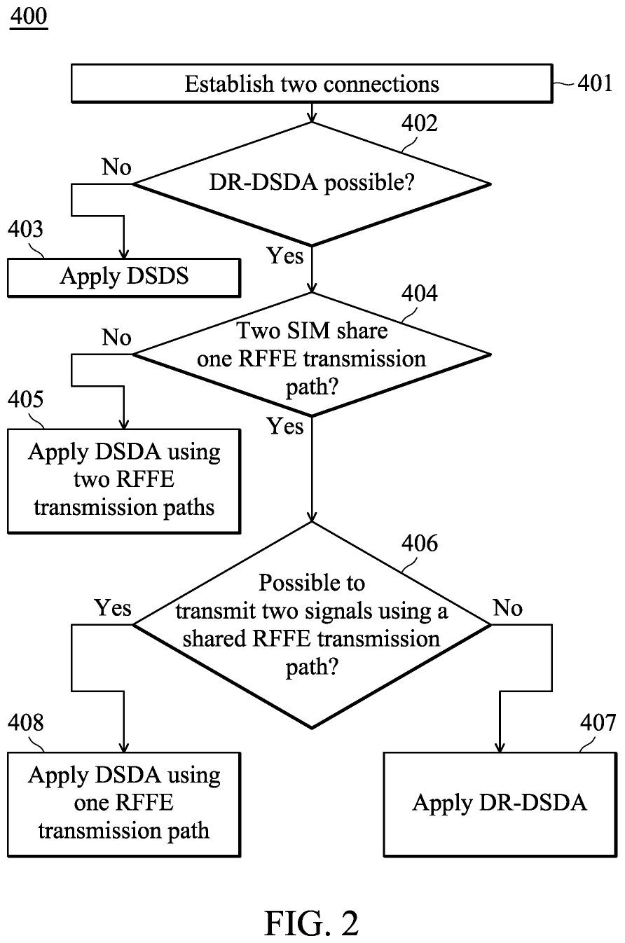

FIG. 2 is a flow diagram of a method 400 in accordance to the embodiments of the present disclosure. The method 400 can be in implemented in the communication system 10 and performed by the electronic device 100. The method 400 starts from operation 401. In operation 401, the electronic device 100 establishes two connections. For example, the electronic device 100 establishes a first connection with the first base station 200 using the first SIM 130 and establishes a second connection with the second base station 300 using the second SIM 140. In operation 402, the processor 110 determines whether DR-DSDA is possible. If no, method 400 proceeds to operation 403. If yes, method 400 proceeds to operation 404. Specifically, the processor 110 determines whether (the RFFE reception paths of) the first SIM and the second SIM are capable of receiving signals transmitted from base stations concurrently. In other words, the processor 110 determines whether the signals transmitted from the base stations to the first SIM 130 and the second SIM 140 can be concurrently received by the RFFE reception paths of the first SIM 130 and the second SIM 140. Whether the signals transmitted to the first SIM 130 and the second SIM 140 can be concurrently received is depend on the receiver (such as RFFE reception path) hardware specification and/or the RF capability of the electronic device 100. For example, hardware specification and/or the RF capability may comprise, but not limited to, the frequency range that antenna can receive, the specification of the filter, and the pass band of the filter. Because whether the signals transmitted to the first SIM 130 and the second SIM 140 can be concurrently received is depend on the hardware specification of the electronic device 100, the signals may be concurrently received when the signals are inter-band or intra-band.

In operation 403, the electronic device 100 applies DSDS to communicate with base stations. In some embodiments, only one of the first SIM 130 and the second SIM 140 is active at one moment. For example, when the first SIM 130 is transmitting or receiving signal, the second SIM 140 cannot transmit or receive signal.

In operation 404, the processor 110 determines whether the first SIM 130 and the second SIM 140 share one RFFE transmission path. If no (i.e. the first SIM 130 and the second SIM 140 respectively has an independent RFFE transmission path), method 400 proceeds to operation 405. If yes (i.e. the first SIM 130 and the second SIM 140 share one RFFE transmission path, as illustrated in FIG. 1), method 400 proceeds to operation 406. In operation 405, the electronic device 100 applies DSDA using two RFFE transmission paths to communicate with base stations.

In operation 406, the processor 110 determines whether it is possible to transmit two signals output from the first SIM 130 and the second SIM 140 using a shared RFFE transmission path. As described above, the first SIM 130 outputs the first signal, and the second SIM 140 outputs the second signal. The processor 110 determines whether the first signal and the second signal are intra-band signals. If the first signal and the second signal are intra-band signals, it is possible to merge two signals and transmit the merged signal through shared RFFE transmission path. If the first signal and the second signal are inter-band signals, the two signals cannot be merged and transmitted through a shared RFFE transmission path. Thus, if the first signal and the second signal are inter-band signals (operation 406, no), method 400 proceeds to operation 407. If the first signal and the second signal are intra-band signals (operation 406, yes), method 400 proceeds to operation 408.

In operation 407, the electronic device 100 applies DR-DSDA to communicate with base stations. The processor 110 may transmit the first signal and the second signal through the RFFE transmission path 150 in a time sharing manner. However, the electronic device 100 may receive the signals of the first base station 200 and the second base station 300 concurrently.

In operation 408, the electronic device 100 applies DSDA using one RFFE transmission path to communicate with base stations. As described above, the processor 110 overlaps (sums up) the first signal and the second signal in the time domain to generate the merged signal. Then, the processor 110 transmits the merged signal on the same carrier through the RFFE transmission path 150. Thus, the first signal and the second signal are transmitted concurrently through the RFFE transmission path 150.

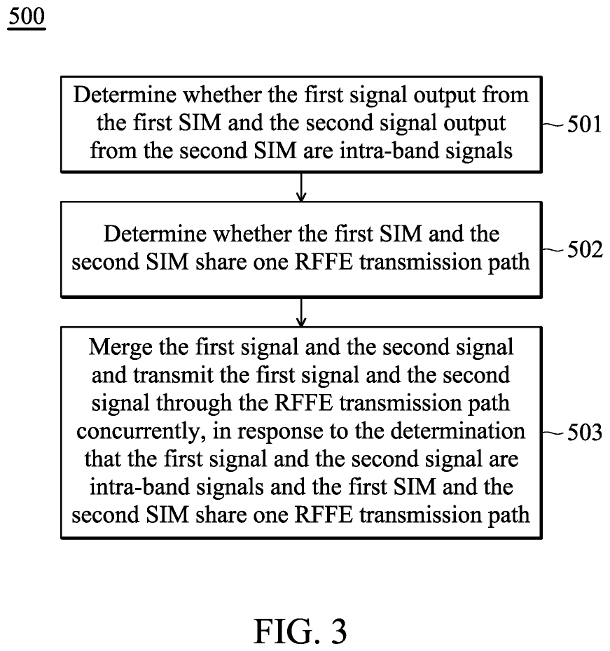

FIG. 3 is a flow diagram of a method 500 in accordance to the embodiments of the present disclosure. Method 500 can be in implemented in the communication system 10 and performed by the electronic device 100. Method 500 starts from operation 501. In operation 501, the processor 110 determines whether the first signal output from the first SIM 130 and the second signal output from the second SIM 140 are intra-band signals. In operation 502, the processor 110 determines whether the first SIM 130 and the second SIM 140 share one RFFE transmission path (i.e. the RFFE transmission path 150). In operation 503, the processor 110 merges the first signal and the second signal and transmits the first signal and the second signal through the RFFE transmission path 150 concurrently, in response to the determination that the first signal and the second signal are intra-band signals and the first SIM 130 and the second SIM 140 share one RFFE transmission path.

Embodiments of the present disclosure can implement DSDA with one RFFE transmission path. Thus, embodiments of the present disclosure can improve uplink performance with lower hardware cost. Embodiments of the present disclosure can also improve downlink performance, because the transmission of the acknowledge (ACK) from the user equipment to the base station is improved.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a first subscriber identity module (SIM);
a second SIM; and
a processor;
wherein the processor is configured to:
merge a first signal from the first SIM and a second signal from the second SIM and transmit the first signal and the second signal through a radio frequency front end (RFFE) transmission path concurrently, in response to a determination that the first signal and the second signal are intra-band signals and the first SIM and the second SIM share one RFFE transmission path.

2. The electronic device as claimed in claim 1, wherein the processor is further configured to overlap the first signal and the second signal in a time domain.

3. The electronic device as claimed in claim 1, wherein the first signal and the second signal are transmitted on the same carrier.

4. The electronic device as claimed in claim 1, wherein the processor is further configured to transmit the first signal and the second signal through the RFFE in a time-sharing manner, in response to a determination that the first signal and the second signal are inter-band signals.

5. The electronic device as claimed in claim 1, wherein the processor is further configured to:
determine whether signals transmitted from base stations to the first SIM and the second SIM can be concurrently received; and
merge the first signal and the second signal and transmit the first signal and the second signal through the RFFE transmission path concurrently, in response to a determination that the first SIM and the second SIM are capable of receiving signals transmitted from base stations concurrently.

6. A method of wireless communication, comprising:
determining, via a processor, whether a first signal from a first subscriber identity module (SIM) and a second signal from a second SIM are intra-band signals;
determining, via the processor, whether the first SIM and the second SIM share one radio frequency front end (RFFE) transmission path; and
merging, via the processor, the first signal and the second signal and transmit the first signal and the second signal through a RFFE transmission path concurrently, in response to a determination that the first signal and the second signal are intra-band signals and the first SIM and the second SIM share one RFFE transmission path.

7. The method of wireless communication as claimed in claim 6, wherein merging the first signal and the second signal comprises:
overlapping, via the processor, the first signal and the second signal in a time domain.

8. The method of wireless communication as claimed in claim 6, wherein the first signal and the second signal are transmitted on the same carrier.

9. The method of wireless communication as claimed in claim 6, further comprising:
determining, via the processor, that the first signal and the second signal are inter-band signals; and
transmitting the first signal and the second signal through the RFFE in a time-sharing manner.

10. The method of wireless communication as claimed in claim 6, further comprising:
determining, via the processor, whether signals transmitted from base stations to the first SIM and the second SIM can be concurrently received; and
merging, via the processor, the first signal and the second signal and transmitting the first signal and the second signal through the RFFE transmission path concurrently, in response to a determination that the first SIM and the second SIM are capable of receiving signals transmitted from base stations concurrently.
